(19) United States
(12) Patent Application Publication
(10) Pub. No.: US 2015/0056588 A1
(43) Pub. Date: Feb. 26, 2015

(54) Electronic Health Care Coach

(71) Applicant: William Halliday Bayer, Rochester, NY (US)

(72) Inventor: William Halliday Bayer, Rochester, NY (US)

(21) Appl. No.: 14/465,666

(22) Filed: Aug. 21, 2014

Related U.S. Application Data
(60) Provisional application No. 61/869,758, filed on Aug. 25, 2013.

(51) Int. Cl. G09B 5/04

(52) U.S. Cl. CPC G09B 5/04
USPC 434/236

(57) ABSTRACT

An Electronic Health Care Coach is provided for patients that have trouble taking their medications or remembering to test for such things as blood sugar and the like. The Electronic Health Care Coach provides voice prompts to the patient to determine compliance with dosing of medications or routine testing. The Electronic Health Care Coach takes the form of a stuffed toy such as a teddy bear and utilizes input sensors that are contained by an appendage of the stuffed toy that are sensitive to human touch. Multiple prompts are employed depending on the responses received. Statistics on patient compliance are collected. The stuffed toy and related voice prompts and input sensors provide a friendly and easy to use reminder system for medications and routine testing that creates a positive experience for the patient, thus increasing patient compliance.

### CROSS-REFERENCE TO RELATED PATENT APPLICATIONS

This application claims priority to U.S. Patent Application Ser. No. 61/869,758 filed Aug. 25, 2013 entitled “Electronic Health Care Coach” by Dr. William Halliday Bayer, the entire disclosure of which is incorporated herein by reference.

### BACKGROUND OF THE INVENTION

1. Field of the Invention

The present invention relates generally to the administration of medications, monitoring and testing, and more specifically to an electronic health care coach for patients having trouble taking their medications or remembering to test for such things as blood sugar and the like.

2. Description of Related Art

Medications must be taken on a regular basis in order to be effective. Many patients have difficulty remembering to take their medications, or may not believe that it is important to comply with the proper and timely dosing of their medications. Similarly, the regular and routine testing of blood sugar in diabetics and various other time sensitive and regular testing activities may require reminders or other patient interaction to ensure effectiveness.

Over the years, there have been various reminder systems designed to remind one to take their medication or perform regular and timely testing. These systems include simple pill dispensers with labels, reminder software, apps for smart phones, alarm clock type reminder devices, and the like. While these systems may be functionally adequate, they are cold and impersonal and oftentimes require an element of expertise in computers or smart phones that many patients simply do not have. Thus, these devices largely go unused, or are at times used not by the patient but by a family member. For example, elderly patients often require frequent and complex dosing of medications. The use of a computer program or a smart phone app is usually not desirable or practical for an elderly patient, and thus the burden of using such a system will fall on a family member or other health care provider.

What is needed is a reminder system for medications and routine testing that is simple to operate and is warm and friendly to the patient. What is further needed is a reminder system such as an electronic health care coach that creates a positive experience for the patient to increase patient compliance.

It is therefore an object of the present invention to provide an electronic health care coach that a patient enjoys interacting with, thus increasing the rate of patient compliance with medication dosing and routine testing while monitoring compliance through logging responses. It is another object of the present invention to provide an electronic health care coach that takes the form of a stuffed animal. It is yet another object of the present invention to provide an electronic health care coach that provides patient input sensors as appendages to the stuffed animal. It is another object of the present invention to provide an electronic health care coach that records patient inputs to generate reports and statistics on patient responses.

These and other objects of the present invention are not to be considered comprehensive or exhaustive, but rather, exemplary of objects that may be ascertained after reading this specification with the accompanying drawings and claims.

### BRIEF SUMMARY OF THE INVENTION

In accordance with the present invention, there is provided an electronic health care coach comprising a first input sensor that provides a binary signal upon sensing actuation; a second input sensor that provides a binary signal upon sensing actuation; a microprocessor configured to provide digitally encoded voice prompts at preset time intervals and react to the binary input signals from the first input sensor and the second input sensor by providing further digitally encoded voice prompts dependent on the state of the binary input signals from the first input sensor and the second input sensor; a decoder player for converting the digitally encoded voice prompts to an analog audio signal, an acoustic speaker electrically connected to the decoder player; an energy storage device to provide electrical power to the microprocessor computer memory electrically coupled to the microprocessor for storing digitally encoded voice prompts and response logic; a stuffed toy containing the microprocessor, decoder player, energy storage device, speaker, sensors and computer memory. In some embodiments of the present invention, the first input sensor is contained by an appendage of the stuffed toy; and the second input sensor is contained by an appendage of the stuffed toy.

The foregoing paragraph has been provided by way of introduction, and is not intended to limit the scope of the invention as described by this specification, claims and the attached drawings.

### BRIEF DESCRIPTION OF THE DRAWINGS

The invention will be described by reference to the following drawings, in which like numerals refer to like elements, and in which:

FIG. 1 is a perspective view of one embodiment of the electronic health care coach of the present invention;

FIG. 2 is a front plan view of the electronic health care coach of FIG. 1;

FIG. 3 is a top plan view of the electronic health care coach of FIG. 1;

FIG. 4 is a bottom plan view of the electronic health care coach of FIG. 1;

FIG. 5 is a right side plan view of the electronic health care coach of FIG. 1;

FIG. 6 is a left side plan view of the electronic health care coach of FIG. 1;

FIG. 7 is a back plan view of the electronic health care coach of FIG. 1;

FIG. 8 is a block diagram of exemplary electronics of the present invention; and

FIG. 9 is a flowchart depicting a method of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims and the attached drawings.

### DESCRIPTION OF THE PREFERRED EMBODIMENTS

For a general understanding of the present invention, reference is made to the drawings. In the drawings, like reference numerals have been used throughout to designate identical elements.

The present invention will be described by way of example, and not limitation. Modifications, improvements and additions to the invention described herein may be determined after reading this specification, claims, and viewing the accompanying drawings; such modifications, improvements, and additions being considered included in the spirit and broad scope of the present invention and its various embodiments described or envisioned herein.

The electronic health care coach of the present invention is described herein by use of a stuffed animal, and as depicted in the drawings, a stuffed bear or teddy bear. This particular embodiment of a teddy bear is provided by way of example only, and is not intended to limit the scope of the present invention. On the contrary, various stuffed toys may be used; for example stuffed animals such as dogs, cats, monkeys, horses, donkeys, zebras, giraffes, goats, cows, sheep, dinosaurs, and the like. Additionally, stuffed toys that are not animals are also considered within the scope of the present invention. The type of stuffed toy to be employed may be determined in part by the preference of the patient, as one of the objectives of the present invention is to provide an electronic health care coach that is identifiable to the patient such that the patient likes interacting with the electronic health care coach, thus increasing compliance. The stuffed toy may comprise, for example, a fabric and a filling, and may be an appealing and non-threatening object to the patient to help with patient acceptance and use of the device.

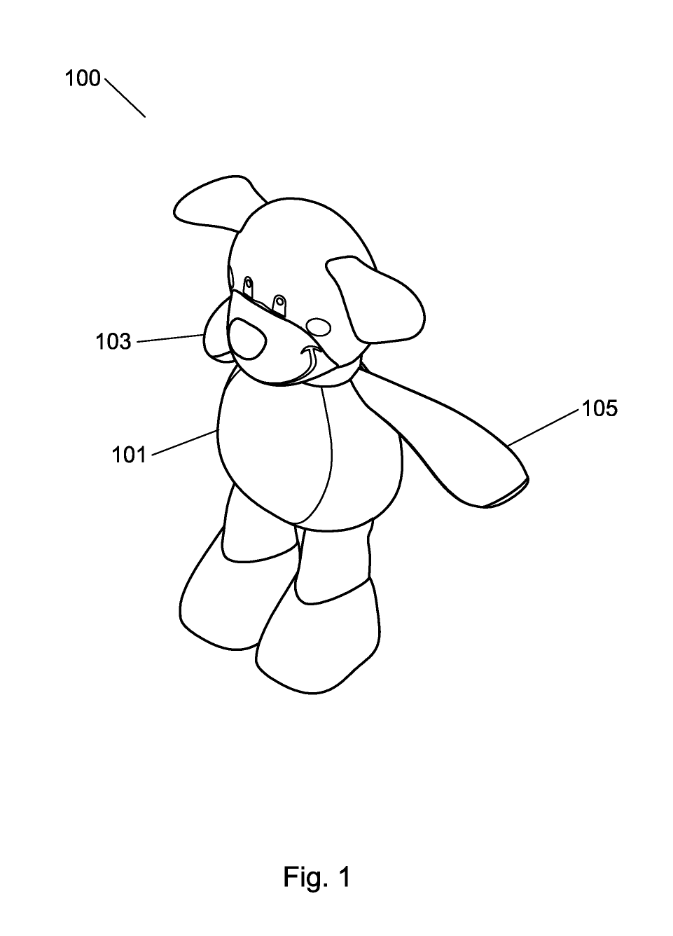

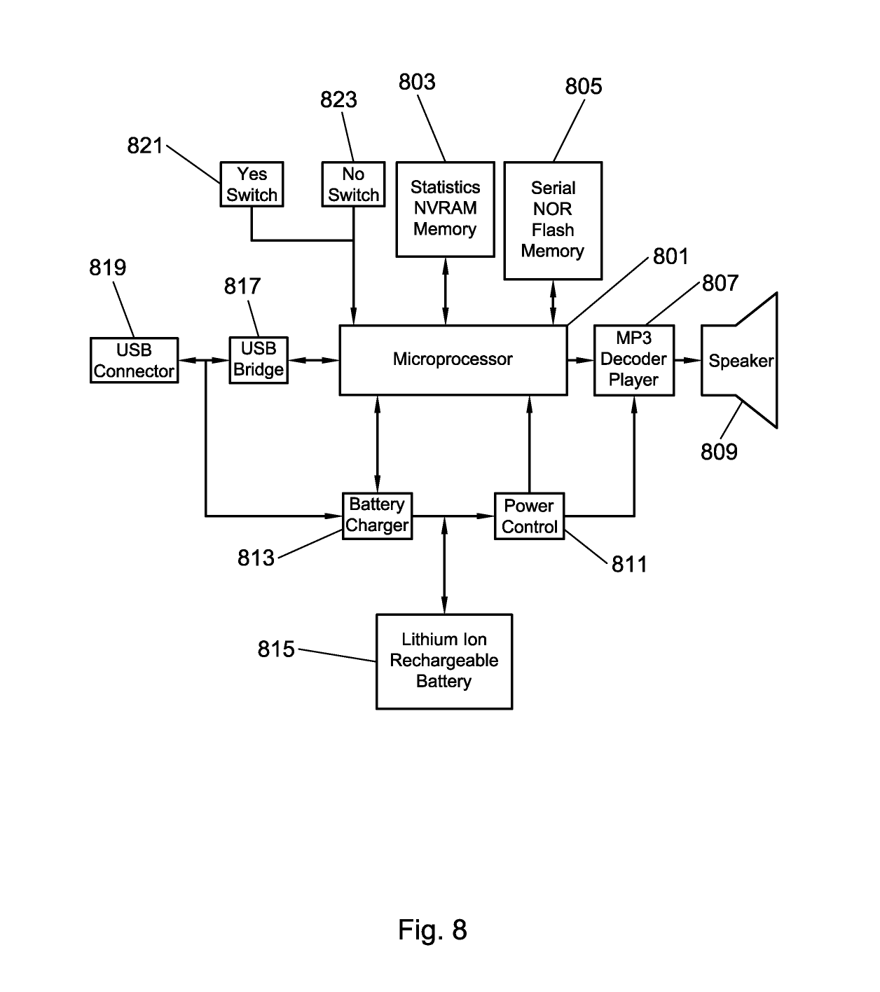

Referring to the present invention in detail, FIG. 1 is a perspective view of one embodiment of the electronic health care coach of the present invention. The embodiment of the electronic health care coach depicted herein is of a teddy bear. While the stuffed toy 101 appears to be an ordinary stuffed toy, the electronics and sensors contained therein provide the functionality required to ensure and increase compliance with medication dosing and routine testing. The stuffed toy 101 may be made from a fabric containing synthetic or natural fibers, and may be made by stitching, gluing, or the like. The stuffed toy 101 contains a first input sensor 103 and a second input sensor 105. In some embodiments of the present invention, there may be additional input sensors, such as, for example, input sensors connected to paws, feet, belly, ears, or the like, of the stuffed toy. The input sensors may be contact switches, proximity switches, infrared sensors, heat sensors, ultrasonic sensors, capacitive sensors, or the like. The input sensors provide a binary signal (a “yes” or a “no”) either directly or indirectly to the microprocessor contained within the stuffed toy 101 (see FIGS. 7 and 8). The input sensors provide this binary signal once the input sensor is actuated by human touch. In some embodiments of the present invention, the binary signal may be as simple as a low impedance and a high impedance state, or may provide a logic level signal such as, for example, +5 volts or 0 volts. The binary signal may also be constructed as a series of binary levels that make up a binary word or binary signal that may then be interpreted by a coder/decoder, microprocessor, microcontroller, or the like. In some further embodiments of the present invention, the input sensor contains, or is operatively coupled to, a device or electronic circuit that takes the output of the input sensor, which may initially be an analog output, and converts it to an appropriate binary signal for use by the microprocessor or microcontroller of the present invention. The input sensors are contained by an appendage of the stuffed toy 101, for example, paws, ears, feet, nose, or the like. The input sensors may be embedded in, contained on the surface of, or otherwise made a part of, the appendage of the stuffed toy. The electrical connections of these input sensors (yes switch and no switch for example) can be seen in FIG. 8. The input of these input sensors may vary and may include one touch for yes and two touches for no, two touches for yes and one touch for no, one touch for yes and no touches for no, one touch for no and no touches for yes, or any of a variety of similar combinations. In some embodiments of the present invention, the first input sensor may be for a positive (yes) response and the second input sensor may be for a negative (no) response. The voice prompts for the electronic health care coach will provide the patient with information on the appropriate response. In some embodiments of the present invention, less than two or greater than two input sensors may be employed. Pressing both sensors in this embodiment would, for example, cause the device to summarize the previous 7, 14, and 21 day responses.

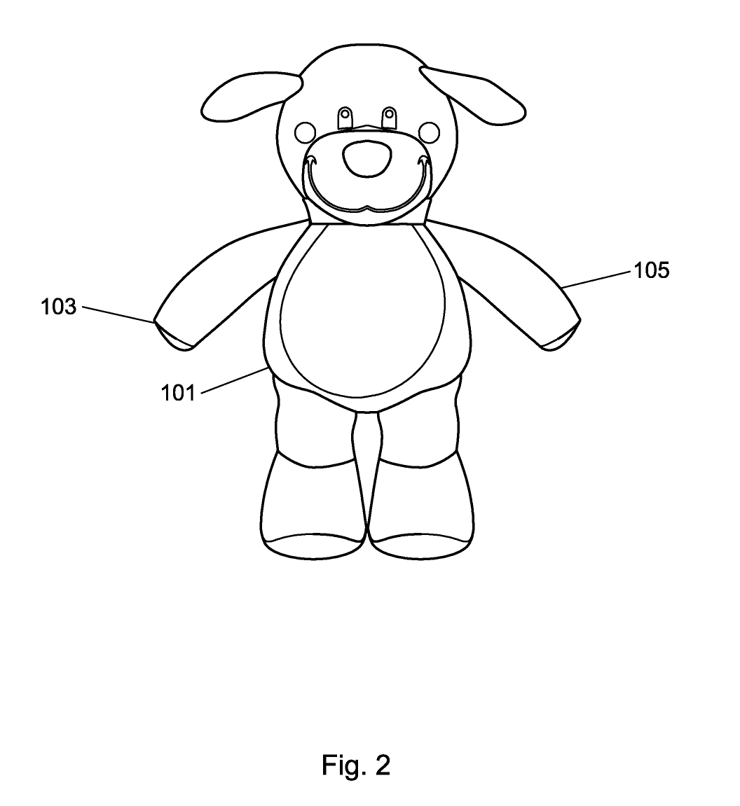

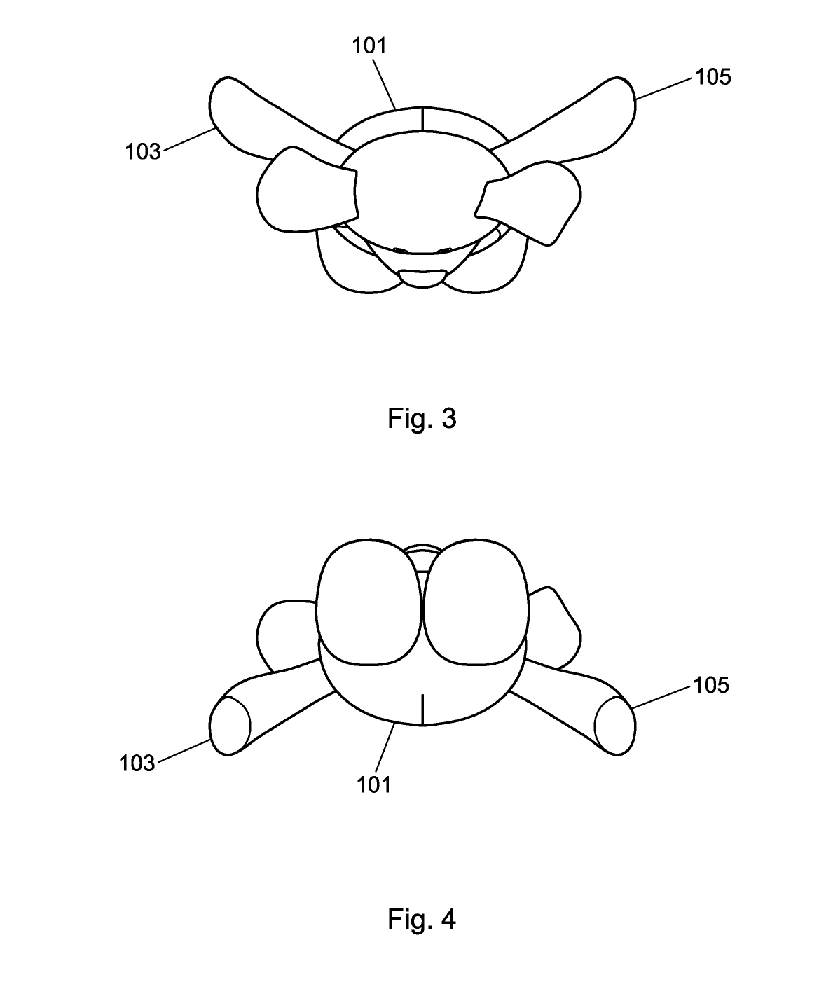

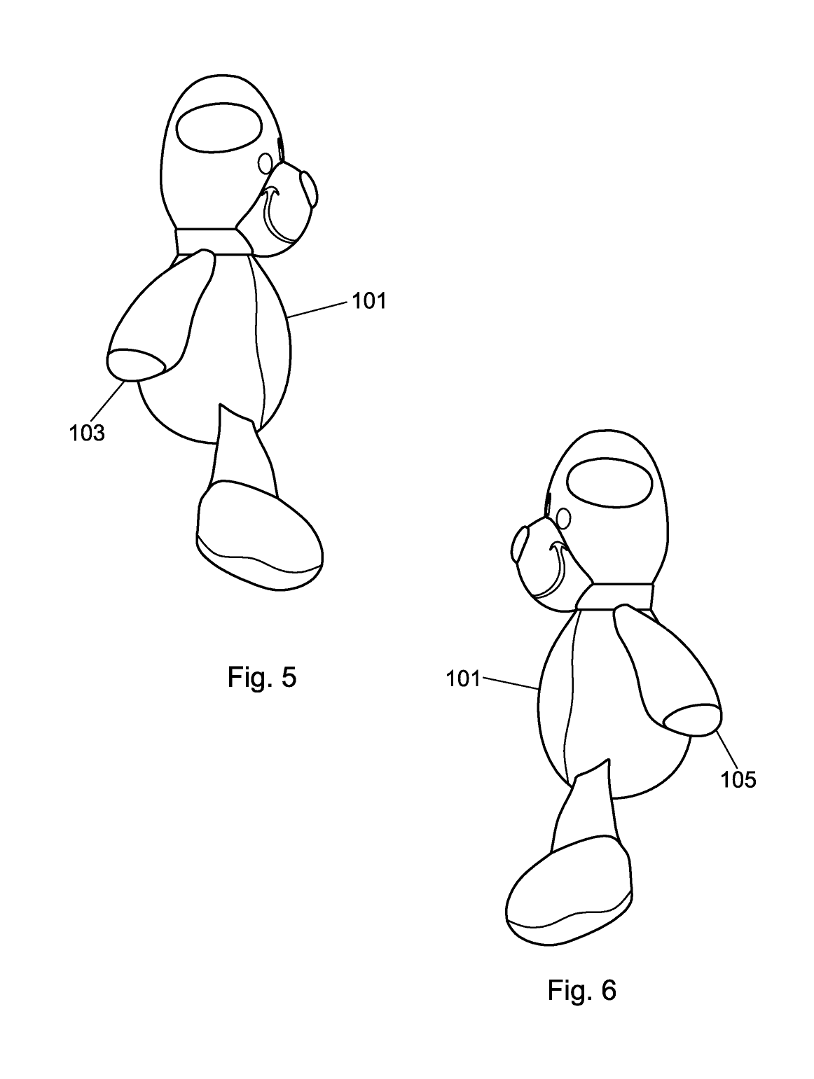

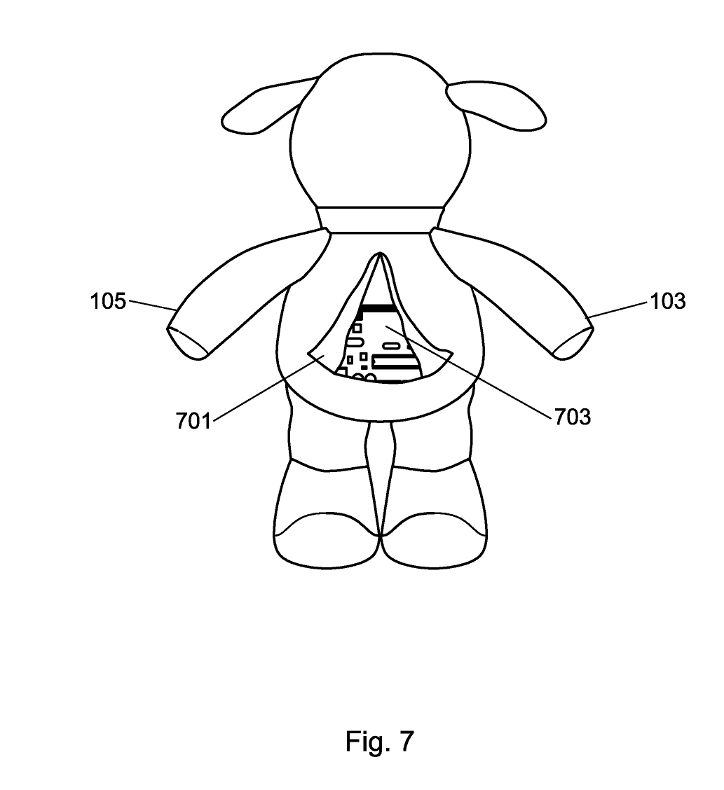

For the sake of clarity, the remaining views of the electronic health care coach 100 are depicted in FIGS. 2-7 where FIG. 2 is a front plan view of the electronic health care coach of FIG. 1. FIG. 3 is a top plan view of the electronic health care coach of FIG. 1. FIG. 4 is a bottom plan view of the electronic health care coach of FIG. 1. FIG. 5 is a right side plan view of the electronic health care coach of FIG. 1. FIG. 6 is a left side plan view of the electronic health care coach of FIG. 1 and FIG. 7 is a back plan view of the electronic health care coach of FIG. 1. In FIG. 7, the access door 701 is in the open position to show the control panel 703. The access door 701 may be a single or multiple flaps of material, or may be hinged, removable, or the like. The material may, in some embodiments of the present invention, be the same fabric of which the stuffed toy 101 is made from. The control panel 703 may contain the various electronic components depicted in FIG. 8, and may also contain some user settings such as volume control, on/off switch, interface connections, battery charging port and the like.

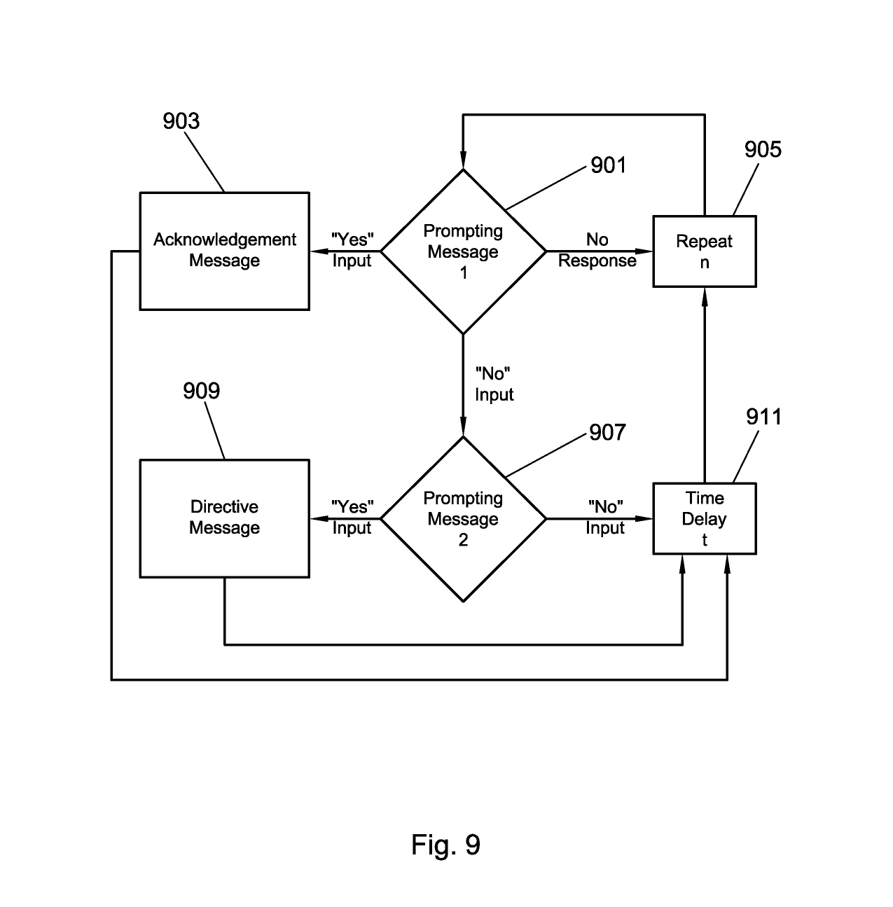

The functionality to be further described by way of FIGS. 8 and 9 includes one or more prompting messages per day. The prompting messages will be annunciated at a predetermined time. A single message having the same meaning may be selected from a collection of messages having the same meaning and presented in random order or in a round robin fashion. The lack of a response to a prompt (no input sensor activation) will generate a new secondary prompt within a fixed time interval. New prompts may be repeated a specified number of times.

An internal real time clock will be employed to initiate prompts at desired times. The speech volume of the prompts can be predetermined. Further, the volume of speech and sound can be adjusted by a volume control that is operatively coupled to an acoustic speaker. The volume control may be a traditional variable impedance device, or may be a digital device that provides digital instructions for volume control to the microprocessor, decoder player, or the like. The voice prompts and sounds are generated using digital encoding, such as, but not limited to, the MP3 sound file format. The voice prompts and sounds may be loaded into the electronic health care coach by way of a physical interface such as USB, and may be prepared off line to contain identifiable voices, for example.

The electronic health care coach will contain functionality to collect statistics on patient compliance. For example, patient responses may be accumulated into an overall rolling statistical summary for 7, 14, and 21 day groups. Patient responses may then be converted to an overall percentage summary for “yes”, “no”, and “no response”. Both primary and secondary responses may be collected for statistical reports. The response summary data may then be extracted from the electronic health care coach by way of an interface such as a USB connection. Spoken statistics may also be employed by appropriate signaling, such as simultaneously pressing and holding both input sensors. A full log of all prompts and patient responses may also be stored in the electronic health care coach and loaded to a host computer that is connected by way of a USB connection or the like. This allows for statistical analysis of the data.

The host computer will also, in some embodiments of the present invention, establish the time of day, day of week, date, and year with the electronic health care coach.

The USB or similar interface between the electronic health care coach and a computer may also include set up functionality such as the number, type and time of prompting events, or charging of the battery. Once established using the computer, this schedule of prompting events can be loaded to the electronic health care coach by an operator such as the patient, a family member or a health care provider.

Patient compliance may be driven by a variety of factors. For example, the voice prompts of the electronic health care coach may be modified in volume, male or female voice, a child's voice, the user's language, animal sounds, contents of the prompt, and the like, to increase patient compliance. In one embodiment of the present invention, the voice prompt increases in volume or other attribute every time no response by the patient is determined (through timing, for example). Additional sounds such as, for example, applause, an alarm clock, whistling, bells, gong, laughing, sobbing, may also be recorded, stored, and presented based on a script, schedule, and user responses. The number and duration of the prompts is only limited by the internal memory capacity of the device. The voice type selection can be made at configuration time. Patient compliance information may be used to modify voice prompts and determine optimal voice prompts to be used for maximum patient compliance. The use of patient compliance information to modify voice prompts may include information only for one specific patient, or may include information from multiple patients that may, in some embodiments of the present invention, be further sorted by patient demographics, age, health, sex, and the like.

FIG. 8 is a block diagram of exemplary electronics of the present invention. A microprocessor 801 can be seen with various interconnections. The microprocessor is configured to provide digitally encoded voice prompts and react to the binary input signals from the first input sensor (821 Yes Switch) and the second input sensor (823 No Switch) by providing further digitally encoded voice prompts dependent on the state of the binary input signals from the first input sensor 821 and the second input sensor 823. The first input sensor 821 and the second input sensor 823 provide a binary signal upon sensing actuation by human touch. Computer memory is electrically coupled to the microprocessor for storing digitally encoded voice prompts and response logic. For example, flash memory 805 may be employed. Further, statistics on patient compliance are collected and stored in statistics memory 803. A decoder player 807 such as an MP3 decoder player converts digitally encoded voice prompts to an analog audio signal that may be further amplified or electrically connected to a speaker 809. The electronics of the present invention requires electrical power from an energy storage device 815 such as a lithium ion rechargeable battery. A power control circuit 811 regulates electrical power delivery to the related electronics and power being received by a battery charger 813. In one embodiment of the present invention, the electronic health care coach will ask by way of a voice prompt to be recharged when the energy storage device 815 requires recharging. To retrieve patient compliance statistics, an electrical interface such as a USB bridge 817 and related USB connector 819 may be employed. Voice based statistics may also be employed using the existing or additional electronics of the electronic health care coach.

The electronics contained within the electronic health care coach are used to provide the methods of the present invention. The electronic health care coach provides various voice prompts and requests patient input to respond to these voice prompts. Based on a patient's response, further voice prompts are provided. For example. FIG. 9 is a flowchart depicting one such method. Examples of the method depicted in FIG. 9 are also provided herein.

In step 901, a prompting message is provided to the patient. Typically, this prompting message asks the patient if they have taken their medication or performed a routine test, such as a blood sugar test. If the patient responds by indicating “yes” through an input sensor (for example, touching the paw of the stuffed toy), an acknowledgement message 903 is provided to the patient acknowledging their positive compliance. If the patient responds by indicating “no” through an input sensor (for example, touching the ear of the stuffed toy), a second prompting message 907 is delivered to the patient. This second prompting message 907 may ask the patient if they are feeling sick. If the patient responds by indicating “yes” through an input sensor (for example, touching the paw of the stuffed toy), a directive message 909 is delivered to the patient, for example, instructing them to call their doctor. If the patient responds by indicating “no” through an input sensor (for example, touching the ear of the stuffed toy), after a time delay t in step 911, the first prompting message 901 is repeated in step 905. The time delay t may be specified within the setup of the electronic health care coach. If after providing the first prompting message 901 there is no response from the patient, the first prompting message 901 is repeated in step 905. As these steps are executed by the microprocessor, response statistics are captured and recorded by way of statistics memory.

The electronic health care coach can also be programmed for single or multiple dosing events, such as daily, twice daily or thrice daily dosing of medications. Similarly, the electronic health care coach can be programmed for single or multiple blood sugar testing.

Personalized office information such as office phone numbers can be inserted into scripts that control the voice prompts. The electronic health care coach will tabulate the patient's responses to keep a running summary such as a 7, 14, and 28 day summary which can be accessed by the patient or other supporting person, such as a visiting nurse, family member, or doctor.

The methods of the present invention include two routines, one for medication compliance, and one for diabetes blood sugar testing. Exemplary routines are described below. Variations on these routines will become evident after reading this specification with the attached drawings and claims, and are to be considered within the scope of the present invention.

### Routine One—

“Hi! Good morning! Did you take your medicine this morning? Press my paw for ‘yes’ or press my ear for ‘no’.”

A/(YES) “Give me a big HUG! (if medicine was taken). I will talk with you soon!”

B/(NO) “I am worried that you are not taking your medicine. Please take it now or call our office at 123-4567 if you are having problems taking your medicine.”

C/(NO ANSWER) “I will be talking with you again every hour until I hear from you. I miss you!”

### Routine Two—

“Did you check your sugar this morning? Press my paw for “yes” or press my ear for ‘no’.”

A/(YES). “Was your sugar over 200? Press my paw for yes, press my ear for no.”
1. (YES). “I am worried that your sugar is too high. Please call our nurse care manager for help with your diabetes at 123-4567. I don't want you to get sick!”
2. (NO). “Give me a big HUG! You are doing great!”
3. (NO ANSWER) “I am still waiting to hear your sugar result!” (Every 45 minutes)

B/(NO). “I think we agreed that you were going to check your sugar every day at this time. You are making me sad! Can you check your sugar now?”
1. (YES)—Go through loop . . . .
2. (NO) “I am feeling a little worried about you. Please call Dr. Smith at 123-4567 and tell us what is going on. I will check back with you later.”
3. (NO ANSWER). “Tasha Teddy is worried about you. I will try and talk with you later.”

C/(NO ANSWER). “I am worried that there is no answer. I will be checking in with you later.”

As indicated above, there would be programmable vignettes for people who are diabetic, non diabetic, and 1, 2, 3 or more times per day medicine takers. Office phone numbers will be programmable as well.

For each routine, various voice prompts are provided to the patient based on a “yes” response, a “no” response, and no response from the patient. Examples of such voice prompts are provided below. Further, opening voice prompts may be provided. Other voice prompts may also be used, and are to be considered within the spirit and broad scope of the present invention.

### Opening Voice Prompts

Wow! I am feeling a little fuzzy today. How about you? Please press my brown paw if you took your medicine. Maybe that will wake me up! Or press the yellow paw if you didn't take is your medicine.
Tasha Teddy says “Only you can be the one to decide to take your pills.” Press my brown paw if you took your pills today. Press the yellow paw if you did not take your pills today.
Have you taken your medicine yet this morning (afternoon)? Press my brown paw if you have taken your medicine or my yellow paw if you haven't taken your medicine.
Your health means a lot to me friend. Did you take your medicine today? Press my brown paw if you took your medicine, or press the yellow paw if you did not take your medicine today.
My paws are itching to know if you took your medicine today. Press my brown paw if you took your medicine or press my yellow paw if you did not take your medicine today.

### Voice Prompt Responses to “Yes”

That's Great. Give me a bear hug! Talk with you later.
Heh! You are smarter than the average bear today! Talk to you later alligator.
That's great! You are my beary best friend! I'll talk later.
You are doing a wonderful job! Friends make life bearable.
Good work! I will talk with you later.
Sweeter than honey! Catch you later.
I hope you feel proud because you should!
Sometimes it isn't easy to take all this medicine, but you are making it happen!
Thanks for putting a smile on my face! Till we meet again.
Good work! Friends make life bearable. I will call again this afternoon (tomorrow morning).
High Five! On second thought, that could be dangerous! Talk to you later.

### Voice Prompt Responses to “No”

I am sorry you haven't taken your medicine. If you are having problems with your medicine please call your pharmacy or your doctor. I will check back with you later.
You have responded that you are not taking your medicine. I wonder why you are not taking it? I couldn't bear to have you get sick. Please call your doctor if you are having trouble taking your meds.
It is not easy taking pills every day. You responded that you did not take them today. Call your doctor if you are having any trouble.
Uh oh. You didn't take your medicine today. I am beary sorry to hear that. Maybe you should call your doctor if you need a refill.

### Voice Prompt Responses to No Response

Hi! I didn't hear from you yet. I hope you are not sick. That would make me beary sad!
Please press my brown paw if you have taken your pills this morning (evening) and my yellow paw if you have not taken the pills.
Hi! I hope you haven't gotten tired of me. I know it is hard to take your medicine regularly. Please press my brown paw if you have taken your medicine and my yellow paw if you did not take your medicine this morning (afternoon).
Hello out there! Can you hear me! I am missing you! Please press the brown paw if you have taken your medicine and the yellow paw if you have not taken your medicine.
It is time to check in, check up, and check out if you took your medicine. Press my brown to paw for “YES!” I took my medicine and my yellow paw for “NO” I didn't take my medicine.
Exsqueeze me friend. I know you must be busy but I just want to know if you are OK. Did you take your medicine today? Press my brown paw . . . .
These voice prompts are not to be considered exhaustive, but rather, are examples of various embodiments and functionality of the present invention. Other voice prompts in addition to sounds may be used as well, and are to be considered to be within the spirit and broad scope of the present invention.

It is, therefore, apparent that there has been provided, in accordance with the various objects of the present invention, an Electronic Health Care Coach.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the present invention as defined by this specification, claims and the attached drawings.

What is claimed is:

1. An electronic health care coach comprising:
a first input sensor that provides a first binary signal upon sensing actuation;
a second input sensor that provides a second binary signal upon sensing actuation;
a microprocessor configured to provide digitally encoded voice prompts and react to the binary input signals from the first input sensor and the second input sensor by providing further digitally encoded voice prompts dependent on the state of the binary input signals from the first input sensor and the second input sensor;
a decoder player for converting the digitally encoded voice prompts to an analog audio signal;
an acoustic speaker electrically connected to the decoder player;
an energy storage device to provide electrical power to the microprocessor;
computer memory electrically coupled to the microprocessor for storing digitally encoded voice prompts and response logic; and
a stuffed toy containing the microprocessor, decoder player, energy storage device, speaker, input sensors and computer memory.

2. The electronic health care coach of claim 1, wherein the first input sensor is contained by a first appendage of the stuffed toy; and the second input sensor is contained by a second appendage of the stuffed toy.

3. The electronic health care coach of claim 2, wherein the first appendage is selected from the group consisting of an arm, a leg, a hand, a foot, a paw, a nose, an ear, a belly, a back, a head, and a tail.

4. The electronic health care coach of claim 2, wherein the second appendage is selected from the group consisting of an arm, a leg, a hand, a foot, a paw, a nose, an ear, a belly, a back, a head, and a tail.

5. The electronic health care coach of claim 1, wherein the first binary signal comprises at least one binary state.

6. The electronic health care coach of claim 1, wherein the second binary signal comprises at least one binary state.

7. The electronic health care coach of claim 1, wherein the first binary signal comprises a plurality of binary states.

8. The electronic health care coach of claim 1, wherein the second binary signal comprises a plurality of binary states.

9. The electronic health care coach of claim 1, wherein the stuffed toy is a bear.

10. The electronic health care coach of claim 1, wherein the stuffed toy is selected from the group consisting of a dog, a cat, a monkey, a horse, a donkey, a zebra, a giraffe, a goat, a sheep, a dinosaur, a bear, and a teddy bear.

11. The electronic health care coach of claim 1, wherein the first input sensor is selected from the group consisting of a contact switch, a proximity switch, an infrared sensor, a heat sensor, an ultrasonic sensor, and a capacitive sensor.

12. The electronic health care coach of claim 1, wherein the second input sensor is selected from the group consisting of a contact switch, a proximity switch, an infrared sensor, a heat sensor, an ultrasonic sensor, and a capacitive sensor.

13. The electronic health care coach of claim 1, further comprising a volume control operatively coupled to the speaker.

14. The electronic health care coach of claim 1, wherein the computer memory is configured to store statistical data on patient compliance.

15. The electronic health care coach of claim 1, further comprising digitally encoded sounds stored on the computer memory electrically coupled to the microprocessor.

16. A method of reminding a patient to comply with instructions, the method comprising the steps of:
providing a first prompting message originating from a stuffed toy;
sensing actuation of an input sensor coupled to the stuffed toy;
providing an acknowledgement message upon sensing a “yes” input from the input sensor;
providing a directive message originating from the stuffed toy upon sensing a “no” input from the input sensor;
repeating the first prompting message when there is no actuation of the input sensor within a predetermined time interval; and
repeating the method of reminding a patient to comply with instructions at a predetermined time interval.

17. The method of claim 16, wherein the instructions are medication compliance instructions.

18. The method of claim 16, wherein the instructions are diabetes blood sugar testing instructions.

19. The method of claim 16, wherein the prompting message increases in volume when there is no actuation of the input sensor within a predetermined time interval.

20. A system for patient compliance comprising:
an input sensor that provides a binary signal upon sensing actuation;
a microprocessor configured to provide digitally encoded sounds and react to the binary input signal from the input sensor by providing further digitally encoded sounds dependent on the state of the binary input signal from the input sensor;
a decoder player for converting the digitally encoded sounds to an analog audio signal;
an acoustic speaker operatively coupled to the decoder player;
a source of electrical power for the microprocessor;
computer memory electrically coupled to the microprocessor for storing digitally encoded sounds and response logic; and
a stuffed toy containing the microprocessor, decoder player, acoustic speaker, input sensor and computer memory.
